(19) United States
(12) Patent Application Publication
(10) Pub. No.: US 2007/0045907 A1
(43) Pub. Date: Mar. 1, 2007

(54) Irregularly textured apparatus for conveying fluid

(76) Inventors: Valerie Salatino, San Diego, CA (US); Nancy Moran, Escondido, CA (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 11/214,173

(22) Filed: Aug. 29, 2005

(51) Int. Cl. B29D 22/00; B28B 7/16

(52) U.S. Cl. 264/573; 138/124; 138/DIG. 11; 249/142

(57) ABSTRACT

An apparatus and method of manufacture that include a hollow tubular structure having an inner surface and an outer surface, with the inner surface being in contact with a fluid and the outer surface including a plurality of irregularly textured areas extending radially from that surface so that frictional engagement with the surface is increased.

### BACKGROUND OF THE INVENTION

1. Field of the Invention

The invention relates generally to a fluid conveying apparatus and method and more particularly to a hose that is especially useful in that it can be securely gripped when wet and is physically camouflaged to blend in with sensitive environments, such as zoo habitats.

2. Description of the Related Art

Many hoses of various types (e.g., garden hoses, fire hoses, utility hoses, etc.) exist have been designed to be structurally improved (e.g., “kink-free”), camouflaged, or aesthetically more pleasing in terms of color or ornamental surface design.

Thus, U.S. Pat. No. D498,825 by Fu discloses a hose having two separate chambers through which water runs. By providing a hose having two chambers with diameters smaller than the same hose would have with a single chamber, the velocity of fluid flow is increased. Also, U.S. Pat. No. 6,789,579 by Ryhman provides a hose with rectangular or other regular geometrical grooves that are uniformly distributed over the hose to provide areas of expansion when the hose is under pressure.

In terms of designs with aesthetic considerations, U.S. Pat. No. D478,969 by Mezzalira, U.S. Pat. No. Des. 381,405 by Waidele et al., and U.S. Pat. No. Des. 413,657 by Lidgett all disclose hoses that feature surface ornamentation consisting of a variety of patterns. All of the surface ornamentations featured in these patents are either regular geometric patterns or non-dimensional (i.e., non-textured) surface adornment. While each of these hoses may be suitable for their intended use, the overall smoothness of the surface of the hose can make them quite slippery when wet. Moreover, all of these hoses tend to stand out from the surrounding environment, making them unsuitable for use in places such as animal habitats. This can be problematic because any foreign object that does not blend-in with the surrounding environment may attract an animal's attention and result in the hose being damaged or in harm being inflicted upon the animal through, for example, accidental ingestion.

U.S. Pat. No. D469,520 by McLean discloses a hose that appears to be designed to resemble a snake. While this design may illicit an avoidance behavior due to its serpent-like appearance, it does not provide any surface features that improve a holder's grip when the hose is wet.

Thus, there remains a need in the art for a hose that mimics a natural environmental feature to provide effective camouflage while also providing surface structure that can improve frictional engagement (e.g., a holder's grip) under wet conditions.

### SUMMARY OF THE INVENTION

The invention relates in general to an apparatus for conveying fluid that includes a hollow tubular member having inner surface and an outer surface with a plurality of irregularly textured areas extending radially therefrom. The invention also relates to a method for manufacturing a hose and to a mold useful in that manufacturing.

In one embodiment of the invention, the apparatus includes a hollow tubular member having an inner surface and an outer surface, with the inner surface being in contact with a conveyed fluid and a plurality of irregularly textured areas extending radially from the outer surface. In certain embodiments, the irregularly textured areas comprise indentations. In other embodiments, the irregularly textured areas include a combination of indentations and protuberances. In still other embodiments, the plurality of irregular textured areas comprise a vine-like appearance. Preferably, the embodiments featuring a vine-like appearance include indentations and protuberances that vary in depth or height from 1/128 inches to 0.5 inches.

In certain embodiments, the apparatus includes a tubular structure with a first material and a second material, wherein a plurality of irregularly textured areas are disposed upon an outer surface of the second material. The first material preferably is a reinforcing material, such as nylon mesh. Also preferably, the first material and second material are integrally formed (rather than disposed atop each other).

In other embodiments of the invention, a method for manufacturing a fluid conveyance apparatus is provided, comprising the step of casting a flexible material into a hollow, tubular structure within a mold, wherein a plurality of irregularly textured areas are formed within an outer surface of, and extend radially from, the tubular structure.

The method of the invention may further include the step of disposing another material within the mold prior to casting the flexible material such that the other material is integrally formed within the flexible material. Preferably, the other material provides a reinforcing material that augments the structural integrity of the tubular structure.

In certain embodiments of the invention, the method includes a unique mold. The mold includes a first mold member defining a tubular structure and having a length and an inner surface in contact with a casting material, wherein the inner surface contains a plurality of irregularly textured areas defining a combination of indentations and protuberances, and a second mold member comprising a cylindrical member disposed substantially centrally along the length of the first mold member.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 schematically depicts a first embodiment of the invention in perspective view.

FIG. 2 schematically illustrates a cross-sectional view taken along line 2-2 in FIG. 1.

FIG. 3 schematically depicts an embodiment of disassembled mold of the invention in elevational view.

FIG. 4 schematically illustrates the assembled embodiment featuring the components of the mold of the invention shown in FIG. 3.

FIG. 5 schematically illustrates another embodiment of the invention in cross-section.

### DETAILED DESCRIPTION OF THE PREFERRED EMBODIMENTS

The invention generally relates to a hollow tubular member having inner surface and an outer surface featuring a plurality of irregularly textured areas extending radially therefrom. The irregularly textured areas are preferably formed during casting.

As used herein, the term “texture” or “textured” is defined as a dimensional quality, as opposed to a flat or smooth aspect, imparted to the exterior of a fluid conveying apparatus.

As used herein, the terms “average outer circumference” is defined as the cross-sectional circumference corresponding to a sectional radius equal to the average radial distance of all protuberance tops and indentation bottoms of the irregularly textured outer surface of the tubular structure.

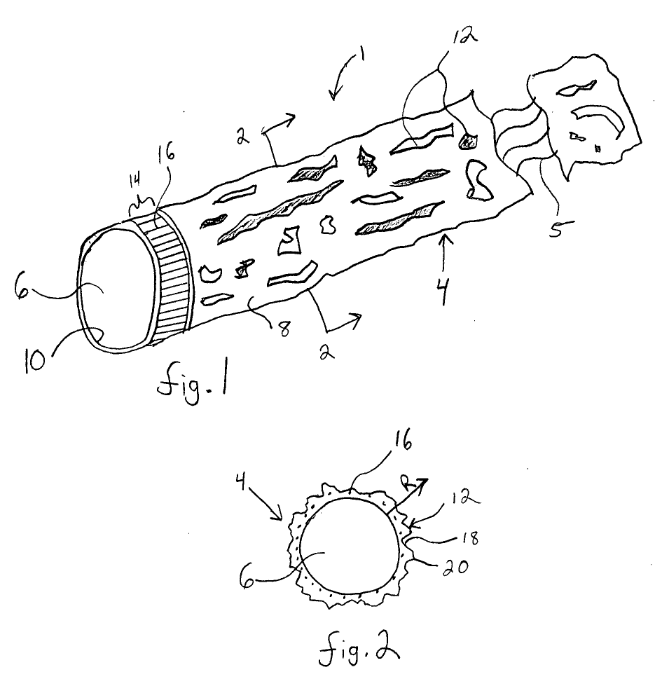

Turning to the figures, wherein like numerals indicate like elements, FIG. 1 illustrates in perspective view a first embodiment of the invention. The apparatus 1 includes a tubular structure 4 defining a hollow area 6 running the length of tubular structure 4. Tubular structure 4 has an outer surface 8 and inner surface 10 that contacts a fluid 5 being conveyed therethrough. Preferably, inner surface 10 is smooth, while outer surface 8 includes a plurality of irregularly textured areas 12 that are integrally formed with surface 8. Also, as exposed in cut-away section 14, the tubular structure 4 preferably contains a second material (in this case nylon chords 16) that is integrally formed between the outer surface 8 and inner surface 10.

One aspect of the plurality of irregularly textured areas is to provide for increased frictional engagement. For example, a user holding the apparatus I under wet conditions would benefit from the irregular texture of the outer surface in that grip would improve. Moreover, augmented frictional engagement between the apparatus 1 and a secondary structure (e.g. a tree branch) is useful for better securing the apparatus in a particular position or location.

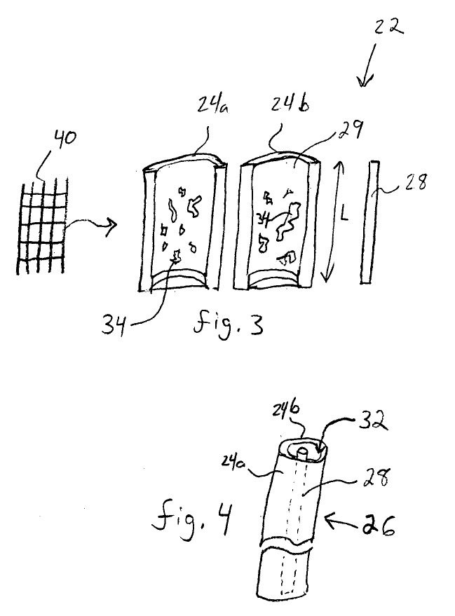

Turning to a cross-sectional view of apparatus 1 along line 2-2, as shown in FIG. 2, the plurality of irregularly textured areas 12 are disposed upon the entire circumference and extend radially (arrow R) from outer surface 8 of tubular structure 4. Again, the tubular structure 4 contains a second material (nylon chords 16), which preferably act as a reinforcing material.

The apparatus 1 of FIGS. 1 and 2 is preferably configured to mimic a natural environmental feature. Thus, the plurality of irregular textured areas 12 may, for example, be configured to provide a vine-like appearance consisting of irregular indentations 18 and irregular protuberances 20.

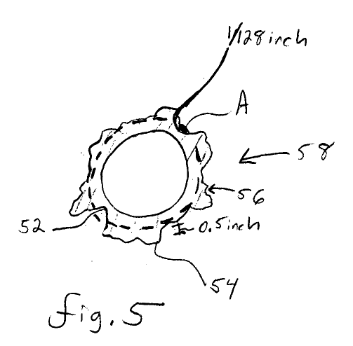

FIGS. 3 and 4 illustrate a mold 22 according to the invention. The mold 22 includes a first mold member 24a and 24b that, when assembled together, define the tubular structure 26 of FIG. 4, and a second mold member 28. The first mold member 24a and 24b have a defined length L and an inner surface 29 in contact with a casting material 32. The inner surface 29 of first mold member 24a and 24b contains a plurality of irregularly textured areas 34 that may be convex, concave or a combination of both, depending on a desired number of indentations and protuberances to appear in the outer surface of the final apparatus.

The second mold member 28 in this embodiment is substantially cylindrical and disposed centrally within, and along the length of, the first mold member 24a and 24b. Reinforcing mesh 40 may be disposed along the inner surface 29 of first mold member 24a and 24b such that mesh 40 will be enveloped by (i.e., made integral with) casting material 32 during the molding process. Upon cooling of the casting material 32, second mold member 28 is removed to reveal a cavity within the casting material.

In one preferred embodiment of the mold 22, the inner surface 29 forms a vine-like appearance that is achieved through indentations and protuberances that vary in depth or height, respectively. The indentations and protuberances may then be further modified (e.g., colored or coated) to suite a particular application.

Another aspect of the invention relates to a method for manufacturing a fluid conveyance apparatus having the following steps: (a) providing a flexible material into a mold defining a hollow tubular structure; and (b) forming a plurality of irregularly textured areas within an outer surface of the tubular structure such that the plurality of irregularly textured areas extend radially from the outer surface. While a manual casting process utilizing the mold of

FIGS. 3 and 4 is contemplated for use according to the method of the invention, injection molding and other techniques known in the art may also be utilized. Moreover, a further step of disposing a material within the mold prior to providing flexible casting material (such as rubber) is preferably practiced to provide the tubular structure with reinforcement.

Following the method of the invention, the apparatus 1 shown in FIG. 1 may be formed. Alternatively, different embodiments, such as that pictured in cross-section in FIG. 5, are created. In the embodiment of FIG. 5, irregularly textured areas are formed to include a combination of indentations 52 and protuberances 54 into the outer surface 56 of tubular structure 58.

Also as shown in FIG. 5, the plurality of irregularly textured areas may be formed to resemble the appearance of a vine or bark consisting of indentations 52 and protuberances 54 that vary from 1/128 inch to 0.5 inch below or above an average outer diameter (the dashed line designated A) of the tubular structure.

In view of the disclosure above, it is readily seen that the invention is especially useful for applications in which a camouflaged hose with improved frictional engagement properties would be desirable.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. An apparatus for conveying fluid, comprising:
a hollow tubular member having an inner surface and an outer surface, said inner surface in contact with a conveyed fluid and said outer surface having a plurality of irregularly textured areas extending radially therefrom.

2. The apparatus of claim 1, wherein said irregularly textured areas comprise indentations.

3. The apparatus of claim 1, wherein said irregularly textured areas comprise a combination of indentations and protuberances.

4. The apparatus of claim 1, wherein said tubular structure comprises a first material and a second material, wherein said plurality of irregularly textured areas are disposed upon an outer surface of said second material.

5. The apparatus of claim 4, wherein said first material is a reinforcing material.

6. The apparatus of claim 1, wherein said plurality of irregular textured areas comprise a vine-like appearance consisting of indentations and protuberances that vary in depth or height from 1/128 inch to 0.5 inch above or below an average outer circumference of said tubular structure.

7. The apparatus of claim 1, wherein said inner surface in contact with a conveyed fluid is smooth.

8. A method for manufacturing a fluid conveyance apparatus, comprising the steps of:
providing a flexible material into a mold defining a hollow tubular structure; and
forming a plurality of irregularly textured areas within an outer surface of said tubular structure, wherein said plurality of irregularly textured areas extend radially therefrom.

9. The method of claim 8, wherein said step of forming said irregularly textured areas includes forming indentations into said outer surface.

10. The method of claim 8, wherein forming said irregularly textured areas includes forming a combination of indentations and protuberances into said outer surface.

11. The method of claim 8, further comprising the step disposing a first material within said mold prior to providing said flexible material such that the first material is integrally formed with said flexible material.

12. The method of claim 11, wherein said first material is a reinforcing material.

13. The method of claim 1, wherein said step of forming the plurality of irregularly textured areas comprises forming a vine-like appearance consisting of indentations and protuberances that vary in depth or height from 1/128 inch to 0.5 inch below or above an average outer diameter of said tubular structure.

14. A mold, comprising:
a first mold member defining a tubular structure and having a length and an inner surface in contact with a casting material, wherein said inner surface contains a plurality of irregularly textured areas; and
a second mold member comprising a substantially cylindrical member disposed centrally within the length of said first mold member.

15. The mold of claim 14, wherein said inner surface defines a combination of indentations and protuberances.

16. The mold of claim 14, wherein said inner surface includes indentations and protuberances that vary in depth or height from 1/128 inch to 0.5 inch.
